(19) United States
(12) Patent Application Publication
(10) Pub. No.: US 2012/0267862 A1
(43) Pub. Date: Oct. 25, 2012

(54) SEALING ELEMENT FOR A FUEL INJECTOR AND A METHOD FOR MANUFACTURING A SEALING ELEMENT FOR A FUEL INJECTOR

(75) Inventors: Mats Lillieroth, Goteborg (SE); Gunnar Akerström, Goteborg (SE); Filip Bergman, Hisings Backa (SE)

(73) Assignee: VOLVO LASTVAGNAR AB, Göteborg (SE)

(21) Appl. No.: 13/382,530

(22) PCT Filed: Jul. 6, 2009
(86) PCT No.: PCT/SE09/00357

§ 371 Date: Feb. 22, 2012

(51) Int. Cl. F02M 61/14; B21D 28/02; F16J 15/08

(52) U.S. Cl. 277/592; 277/591; 72/338

(57) ABSTRACT

A sealing element is provided for a fuel injector provided in a cylinder head of an internal combustion engine. The sealing element includes carrier element of a first material, where the carrier element is ring shaped with an upper essentially planar surface and a lower essentially planar surface. A first gasket material is provided on a first portion of at least one of the upper or lower surfaces. A second gasket material is provided on a second portion of the at least one of the upper or lower surfaces where the first gasket material is provided, wherein the first gasket material is provided on an outer region of the planar surface of the ring shaped carrier element and the second gasket material is provided on an inner region of the planar surface of the ring shaped carrier element and where the second gasket material is softer than the first gasket material.

### BACKGROUND AND SUMMARY

The invention relates to a sealing element.

The sealing of the fuel injector is important, particularly for diesel engines and more particularly for heavy duty diesel engines in which the cylinder pressure can reach as much as 200 bar or even beyond that value. With a cylinder pressure at this level and temperatures in the range of −40 to several hundreds degrees of Celsius puts enormous demands on the interface between the fuel injector and the cylinder head of the internal combustion engine.

Traditionally, gaskets provided between the fuel injector and the cylinder head have the purpose to seal the injector to the cylinder head.

A soft gasket between the fuel injector and the cylinder head will seal in the beginning, but is susceptible to relaxation when temperature variations and tightening pressure of the fuel injector to the cylinder head had lasted a predetermined time. This may cause a leakage.

A hard gasket will put special requirements on the surfaces and such gasket may be very sensitive to misalignment of the fuel injector installation.

In GB 1 322 943 it is suggested to coat one or both sides of a metal washer with a flowable material. The problem with such a design is that misalignment cannot be taken care of and after some time when said gasket has been installed it will start to leak which is a problem.

It is desirable to provide an improved sealing gasket which reduces or eliminates the above mentioned problems.

In a first aspect of the present invention it is provided a sealing element for a fuel injector provided in a cylinder head of an internal combustion engine. Said sealing element comprising a carrier element of a first material, where said carrier element is ring shaped with an upper essentially planar surface and a lower essentially planar surface, a first gasket material provided on a first portion of at least one of said upper or lower surfaces. A second gasket material is provided on a second portion of the at least one of said upper or lower surfaces where said first gasket material is provided. Said first gasket material is provided on an outer region of said planar surface of said ring shaped carrier element and said second gasket material is provided on an inner region of said planar surface of said ring shaped carrier element and where said second gasket material is softer than the first gasket material.

An advantage of this example embodiment of the present invention is that an inexpensive sealing gasket may be provided with sealing capabilities for misaligned and prolonged installations.

In another example embodiment of the present invention said second gasket material is thicker than the first gasket material.

An advantage of this example embodiment is that relatively big misalignment may be sealed by such a gasket.

In still another example embodiment of the present invention said first and second gasket materials are made of the same material but with the first gasket material deformation hardened.

An advantage of this example embodiment is that the manufacturing cost may be kept at a minimum.

In yet another example embodiment of the present invention said carrier element may be made of steel and said first and/or second gasket material may be made of one or more of the materials in the group of: Cu, bronze, Sn, Zn, Al, Pb and/or Cd.

An advantage of this example embodiment is that thin inexpensive gaskets may be manufactured which are still easy to handle.

In a second aspect of the present invention it is provided a method for manufacturing a sealing element for a fuel injector comprising the steps of providing a carrier element of a first material, providing a gasket material on at least a front side or a backside of said carrier element, punching a ring shaped sealing element from said carrier element with said gasket material provided on it. Said method further comprising the step of forming on an outer region of said ring shaped sealing element a deformation hardened gasket material in the same step as said ring is punched out from said carrier element with said gasket material provided on it.

An advantage of this example embodiment of the present invention is that an inexpensive sealing gasket may be provided with sealing capabilities for misaligned and prolonged installations.

In another example embodiment of the present invention said deformation hardened outer region of said ring shaped material is having a smaller thickness compared to a non deformation hardened inner region of said ring shaped sealing element.

An advantage of this example embodiment of the present invention is that relatively big misalignment may be sealed by such a gasket.

In still another example embodiment of the present invention said carrier element may made of steel and/or said first and/or second gasket material may be made of one or more of the materials in the group of: Cd, Cu, bronze, Sn, Zn, Al and/or Pb.

An advantage of this example embodiment is that thin inexpensive gaskets may be manufactured which are still easy to handle.

### BRIEF DESCRIPTION OF THE DRAWINGS

The present invention together with the above-mentioned and other objects and advantages may best be understood from the following detailed description of the embodiments, but not restricted to the embodiments, wherein is shown schematically:

FIG. 1 depicts a sectional view of a first example embodiment of a sealing element according to the present invention.

FIG. 2 depicts a partial sectional view of a second example embodiment of the sealing element according to the present invention.

FIG. 3 depicts a partial sectional view of a second example embodiment of the sealing element according to the present invention.

FIG. 4 depicts a sectional view of an example embodiment of the present inventive sealing element together with a force/deformation diagram.

FIG. 5 depicts a sectional view of a sealing gasket provided under a misaligned fuel injector.

In the drawings, equal or similar elements are referred to by equal reference numerals. The drawings are merely schematic representations, not intended to portray specific parameters of the invention. Moreover, the drawings are intended to depict only typical embodiments of the invention and therefore should not be considered as limiting the scope of the invention.

### DETAILED DESCRIPTION

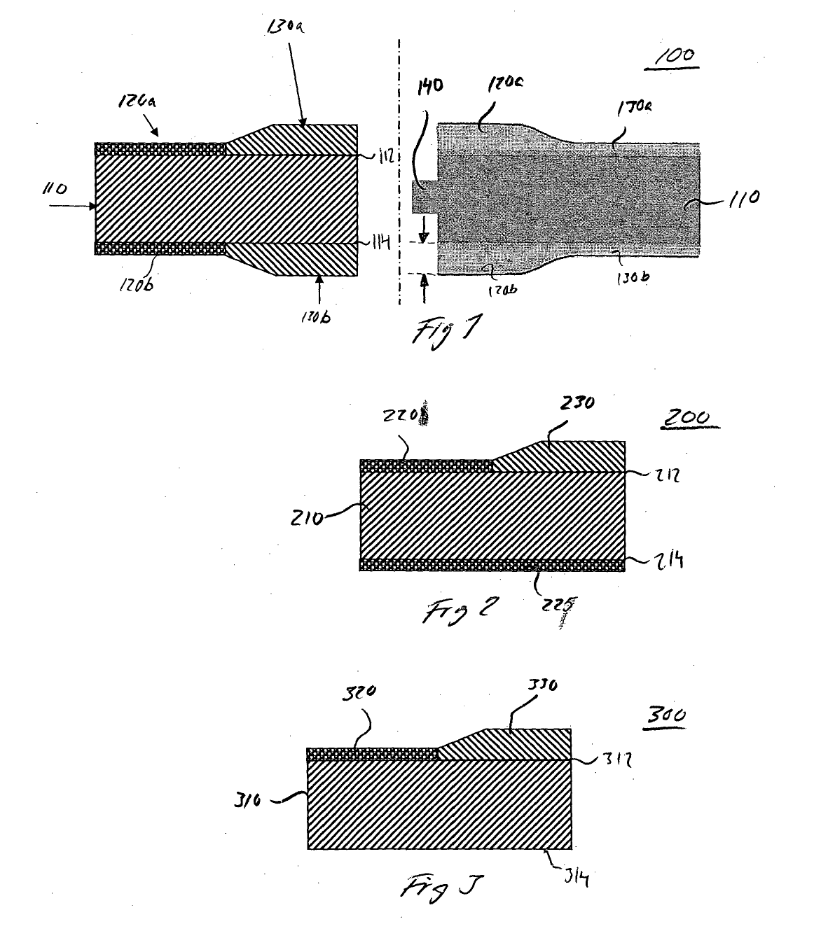

FIG. 1 depicts a sectional view of a first example embodiment of a sealing element 100 according to the present invention. Said sealing element 100 comprising a carrier element 110 and a gasket material 120a, 120b, 130a, 130b.

Said carrier element 110 may be made of iron or iron alloys.

Said carrier element 110 may be ring shaped with an upper essentially planar surface 112 and a lower essentially planar surface 114.

The gasket material 120a, 120b, 130a, 130b is provided on at least one of said upper or lower surfaces 112 and 114 respectively. Said gasket material 120a, 120b, 130a, 130b may be made of a material which can easily be deformation hardened, such as Cu, Sn, Bronze, Zn, Al, Pb and/or Cd or any alloy of said materials.

Gasket material 120a, 120b, which is provided on an outer region of said carrier element 110 has a smaller thickness compared to the gasket material 130a, 130b which is provided on an inner region of said carrier element 110. The gasket material 120a, 120b provided on said outer region of said carrier element 110 is harder than the gasket material 130a, 130b provided on said inner region of said carrier element 110. The hardness of said gasket material 120a, 120b in said outer region may be made by deformation hardening in the same step as punching out the sealing element from a large sheet of sealing element material or in a separate step. As an alternative said gasket material 120a, 120b on said outer region of said carrier element 110 may be different in composition compared to the gasket material 130a, 130b in the inner region of said carrier element 110. In FIG. 1, the right hand side of the sectional view illustrated an optional flange 140 which is provided on said carrier element 110 as an extension towards the centre of the sealing element 100. Said flange 140 may be used for aligning the sealing element 110 to a fuel injector tip.

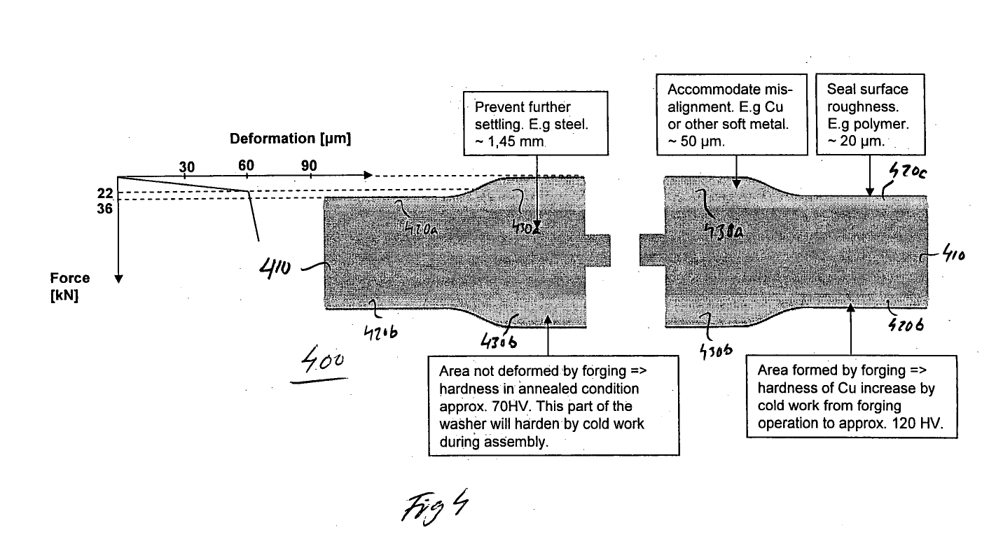

FIG. 2 illustrates a second example embodiment of the present invention of a sealing element 200. The difference to the sealing element 100 according to FIG. 1 is that the carrier element 210 has a lower surface 214 onto which a homogenous gasket material 225 is provided, i.e., with no difference in hardness and height difference as gasket materials 220, 230 which are provided on the upper surface 212 of said carrier element 210. Said homogenous gasket material 215 provided on said lower surface 214 of said carrier element 210 may be made of a relatively soft material, for instance Cu, Sn, Bronze, Zn, Al, Pb and/or Cd or any alloy of said materials.

FIG. 3 illustrates a second example embodiment of the present invention of a sealing element 300. The difference to the sealing element 200 according to FIG. 2 is that the carrier element 310 has a lower surface 314 which is not provided with any gasket material, i.e., a bare lower carrier element surface.

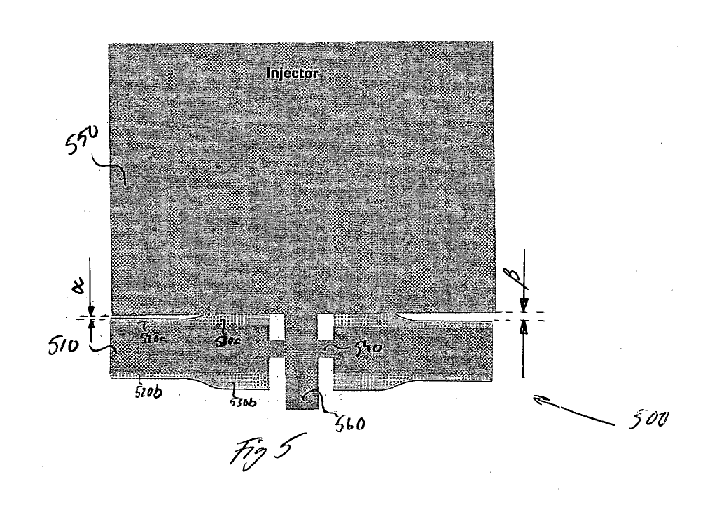

FIG. 4 illustrates a sectional view of an example embodiment of the present inventive sealing element 400 together with a force/deformation diagram.

According to the force/deformation diagram the gasket material 430a, 430b provided in said inner region of said carrier element 410 in much softer than the gasket material 420a, 420b provided in the outer region of said carrier element 410. The thickness of the carrier element may be in the range of some tenth of millimetres to several millimetres, in the embodiment as depicted in FIG. 4 said thickness is 1.45 mm. The thickness of the gasket material 420a, 420b in the outer region of the carrier element 410 may be 0.10-0.50 mm, in the example embodiment in FIG. 4 said thickness is 0.16 mm.

The thickness of the gasket material 430a, 430b in the inner region of the carrier element 410 may be 0.20-1 mm thick, in the embodiment as depicted in FIG. 4 said thickness is 0.5 mm.

The hardness of the gasket material 430a, 430b in the inner region of the carrier element 410 may be over 100 HV and in the example embodiment in FIG. 4 said hardness is 70 HV. The hardness of the gasket material 420a, 420b in the outer region of the carrier element 410 may be 100-200 HV and in the example embodiment in FIG. 4 said hardness is 120 HV.

Optionally said gasket material 420a, 420b, 430a, 430b is covered with a thin layer of polymer. This thin layer of polymer is used for eliminating any surface rougness that may be present after the cold work deformation hardening of the gasket material. Said polymer may also be present on the lower surface of the carrier element in FIG. 3.

FIG. 5 depicts a sectional view of a sealing element 500 provided under a misaligned fuel injector 550. The misalignment is illustrated in FIG. 5 as a distance a on the left hand side and a distance b on the right hand side, where b is clearly larger than a. It is also illustrated that the inventive sealing element 500 takes up the misalignment of the injector and seal said injector to the cylinder head (not shown). In the illustrated example embodiment in FIG. 5, said carrier element is provided with said flange 540 for aligning the sealing element 500 to the injector tip 560. Since the inner gasket material 530a, 530b is soft, the misalignment will depress the inner gasket material uneven around the sealing element 500, i.e., the cold work deformation hardening of the inner region gasket material 530a1 530b will be uneven due to the misaligned injector.

1. A sealing element for a fuel injector provided in a cylinder head of an internal combustion engine, said sealing element comprising:
a. a carrier element of a first material, where said carrier element is ring shaped with an upper essentially planar surface and a lower essentially planar surface,
b. a first gasket material provided on a first portion of at least one of said upper or lower surfaces, characterized in that
c. a second gasket material provided on a second portion of the at least one of said upper or lower surfaces where said first gasket material is provided, wherein said first gasket material is provided on an outer region of said planar surface of said ring shaped carrier element and said second gasket material is provided on an inner region of said planar surface of said ring shaped carrier element and where said second gasket material is softer than the first gasket material.

2. The sealing element according to claim 1, wherein said second gasket material is thicker than the first gasket material.

3. The sealing element according to claim 1 or 2, wherein said first and second gasket materials are made of the same material but with the first gasket material deformation hardened.

4. The sealing element according to any one of claim 1-3, wherein said carrier element is made of steel and said first and/or second gasket material is made of one or more of the materials in the group of: Cd, Cu, bronze, Sn, Zn, Al, Pb and/or Cd.

5. A method for manufacturing a sealing element for a fuel injector comprising the steps of:
a. providing a carrier element of a first material
b. providing a gasket material on at least a front side or a backside of said carrier element,
c. punching a ring shaped sealing element from said carrier element with said gasket material provided on it, characterized in that said method further comprising the step of
d. forming on an outer region of said ring shaped sealing element a deformation hardened gasket material in the same step as said ring is punched out from said carrier element with said gasket material provided on it.

6. The method according to claim 5, wherein said deformation hardened outer region of said ring shaped material is having a smaller thickness compared to an non deformation hardened inner region of said ring shaped sealing element.

7. The method according to claim 5 or 6, wherein said carrier element is made of steel and/or said first and/or second gasket material is made of one or more of the materials in the group of: Cd, Cu, bronze, Sn, Zn, Al and/or Pb.
